(19) United States
(12) Patent Application Publication
(10) Pub. No.: US 2005/0237700 A1
(43) Pub. Date: Oct. 27, 2005

(54) Power assemblies, methods and uses thereof

(76) Inventor: George Thompson, Spokane Valley, WA (US)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/517,727

(22) PCT Filed: Jun. 18, 2003
(86) PCT No.: PCT/US03/19101

§ 371 Date: Dec. 10, 2004

Related U.S. Application Data
(60) Provisional application No. 60/389,906, filed on Jun. 18, 2002.

(51) Int. Cl. H02J 7/00

(52) U.S. Cl. 361/659; 307/150; 324/110; 324/659

(57) ABSTRACT

A power assembly system is disclosed that includes a) a collar unit; and b) an internal power unit, wherein the internal power unit is coupled to the collar unit. A power assembly couple is also disclosed that includes a) the power assembly system described herein; and b) a meter base assembly, wherein the meter base assembly is coupled to the power assembly system to form the power assembly couple. Methods of forming a power assembly system are provided herein that include: a) providing a collar unit; b) providing an internal power unit; and c) coupling the collar until to the internal power unit. Also, methods of forming a power assembly couple are disclosed herein that include: a) providing the power assembly system described herein; b) providing a meter base assembly; and c) coupling the power assembly system with the meter base assembly to form the power assembly couple.

This application claims priority to U.S. Provisional Application Ser. No. 60/389,906 filed on Jun. 18, 2002, which is commonly owned and incorporated by reference herein in its entirety.

### FIELD OF THE SUBJECT MATTER

The field of the subject matter is power assemblies coupled to meter base assemblies in residential and commercial applications.

### BACKGROUND

Commercial and residential consumers are steadily increasing their purchasing and use of electronics and broadband communications (including Ethernet) components and products, as these electronics and broadband communications components replace traditional, and in some cases obsolete, electronics and communications products. This increase has led to a demand for smaller, more efficient, easier to install and flexible power assemblies, sources, supplies and power shields.

Traditional and/or conventional power assemblies, supplies and sources are generally installed indoors and require an electrical outlet. However, with emerging broadband services models which include fiber-to-the-home, cable and wireless delivery methods, access equipment is often deployed outdoors. In those instances an electrician or other licensed professional and possibly an electrical permit is required to connect and configure the power assembly properly. These power supplies and assemblies can be cumbersome and costly to install in smaller homes and apartments, can be destructive to property and non-removable in leased commercial space, and can be completely unmanageable in an older home that likely has significant wiring considerations and/or inadequate/poor wiring for today's electronic and communications devices.

An example of conventional prior art indoor power supplies and sources is the PowerShield™ line of products produced by APC. The Integrated Access Device (IAD) of the PowerShield™ line is a wall mount unit. The installation instructions highlight the inherent disadvantages of these devices, including a) these devices must be installed by “qualified service personnel”; b) these devices are not designed to be used outside or in extreme conditions; and c) these devices are strictly AC powered systems, which requires a local electrical permit in most instances if outdoor installation was attempted. Another example of a conventional power art power supply system is the AlphaPoint Network Interface Unit Power Supply. This system has similar disadvantages as the PowerShield™, as mentioned earlier.

Therefore, a power assembly system needs to be developed that a) can be and is designed to operate outside and in relatively extreme conditions, as compared to prior art devices, such as those mentioned earlier; b) is designed to be installed without a local electrical permit and/or an electrician; c) doesn't require specialized wiring or new wiring to install properly; and d) can be used in the smallest of homes or businesses, as long as the home or business is using “metered electricity”.

### SUMMARY OF THE SUBJECT MATTER

The subject matter herein is directed to a power assembly system that includes a) a collar unit; and b) an internal power unit, wherein the internal power unit is coupled to the collar unit.

The subject matter is further directed to a power assembly couple that includes a) the power assembly system described herein; and b) a meter base assembly, wherein the meter base assembly is coupled to the power assembly system to form the power assembly couple.

In addition, methods of forming a power assembly system are provided herein that include: a) providing a collar unit; b) providing an internal power unit; and c) coupling the collar until to the internal power unit.

Also, methods of forming a power assembly couple are disclosed herein that include:
a) providing the power assembly system described herein; b) providing a meter base assembly; and c) coupling the power assembly system with the meter base assembly to form the power assembly couple.

### BRIEF DESCRIPTION OF THE FIGURES

FIG. 1 shows a contemplated embodiment of the power assembly system.

FIG. 2 shows a contemplated embodiment of the power assembly system.

Table 1 shows requirements and data for a contemplated PC25 power unit.

### DETAILED DESCRIPTION

In order to address many of the disadvantages of previously discussed specialized prior art power supplies and sources, a power assembly system and related methods and uses thereof has been developed that takes advantage of existing connection ports, while requiring less specialized installation techniques and personnel. Specifically, a power assembly has been developed that a) can be and is designed to operate outside and in relatively extreme conditions, as compared to prior art devices, such as those mentioned earlier; b) is designed to be installed without a local electrical permit and/or an electrician; c) doesn't require specialized wiring or new wiring to install properly; and d) can be used in the smallest of homes or businesses, as long as the home or business is using “metered electricity”.

As used herein, the phrase “metered electricity” means that electricity that is being received from a local or relatively proximate utility company or service wherein the use of that electricity is measured by a meter placed at or near the residence or business location. In some cases, the power assembly systems contemplated herein will comprise two or more of the benefits and advantages listed above, but it should be appreciated that power assembly systems contemplated herein may only comprise one of the benefits/advantages shown above, and that in no way limits the inherent usefulness of the power assembly system.

Power assemblies contemplated herein are designed to be coupled between a meter base and a meter (herein collectively referred to as the “meter base assembly”). The meter base assembly measures the amount of electricity consumed by the commercial or residential location. Preferred power assemblies comprise a collar unit coupled to an internal power unit.

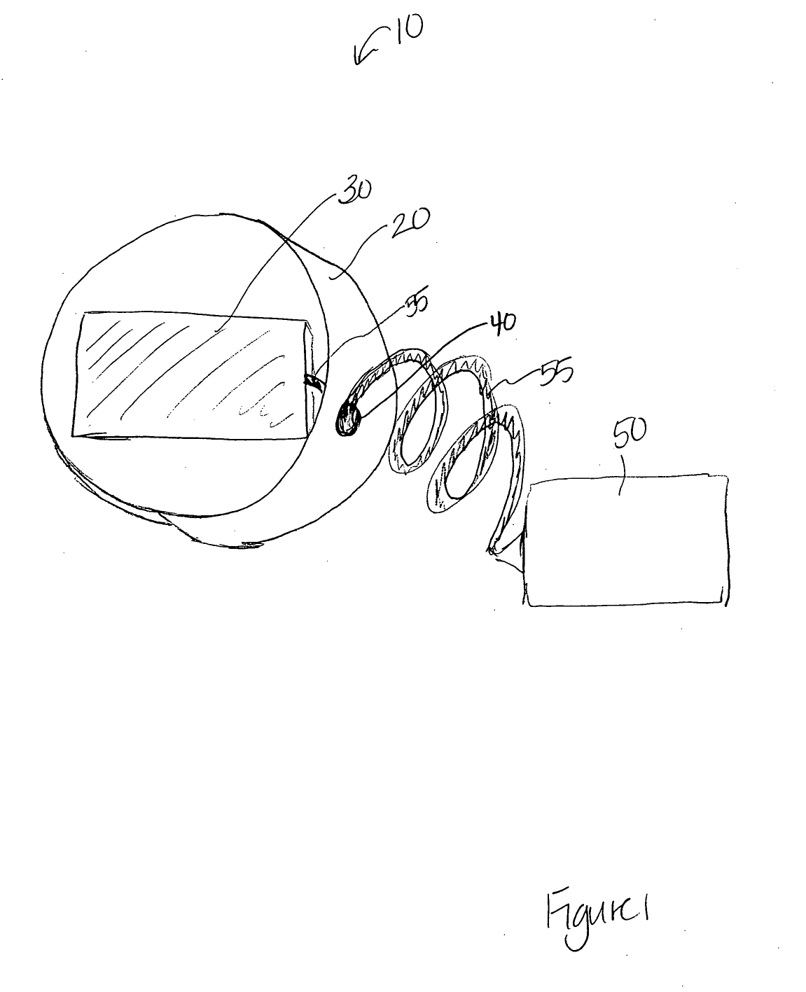

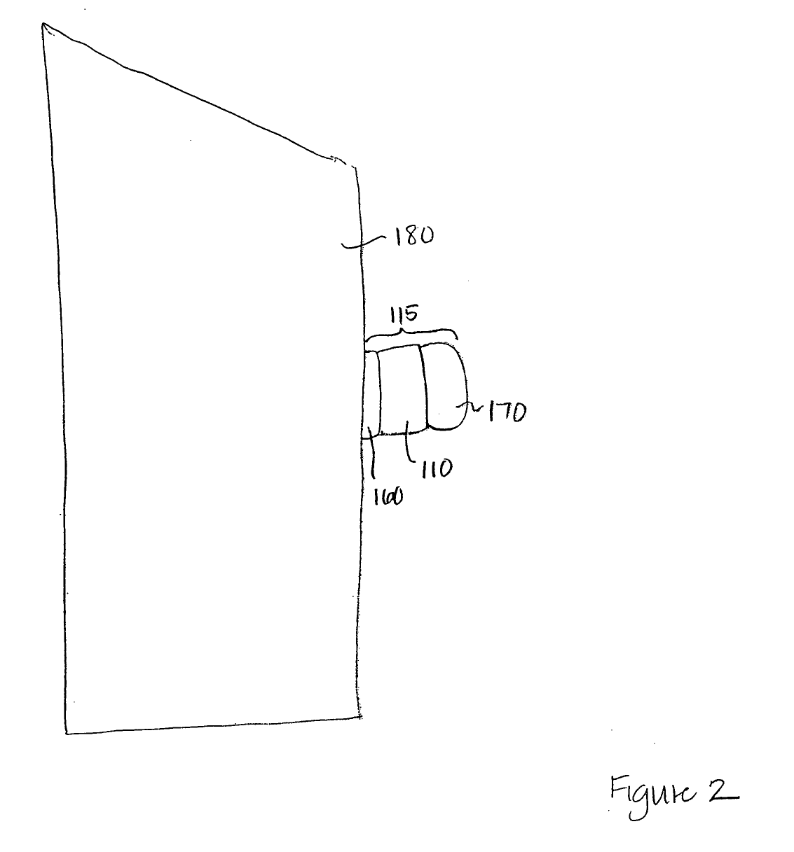

FIG. 1 shows a power assembly system 10 that comprises a collar unit 20 that is coupled to an internal power unit 30. The collar unit 20 is designed so that it couples easily to a meter base and/or a meter (not shown) to form a power assembly couple (also not shown). The collar unit 20 also comprises ports and openings 40, such that the power unit 30 can be coupled to an external component 50, such as an electronic component, a communications component or some other suitable component and/or combination thereof. FIG. 2 shows a contemplated embodiment of a power assembly system 100 that is coupled to a meter base 160 and a meter 170 to form a power assembly couple 1115, wherein the meter base 160 is coupled to the side wall of a residential or commercial structure 180.

A collar unit generally comprises a material that can be molded into a casing or collar unit, such as by ejection molding. The material may comprise a suitable material, including polymers, monomers and other compounds. Suitable materials generally comprise those materials that are a) capable of providing sufficient protection for the internal power unit, b) durable, and c) relatively easy to work with. As used herein, the term “polymer” means those compounds that comprise any suitable combination of organic, organometallic or inorganic molecules or monomers, any of which may or may not comprise a polymer. Examples of contemplated organic polymers are polyimides, polyethers, polyesters, or polybenzils. Examples of contemplated organometallic polymers are various substituted polysiloxanes. Examples of contemplated inorganic polymers include silicate or aluminate. Contemplated polymers may also comprise a wide range of functional or structural moieties, including aromatic systems, and halogenated groups. Furthermore, appropriate polymers may have many configurations, including a homopolymer, and a heteropolymer. Moreover, alternative polymers may have various forms, such as linear, branched, super-branched, or three-dimensional. The molecular weight of contemplated polymers spans a wide range, typically between 400 Dalton and 400000 Dalton or more.

As used herein, the term “monomer” refers to any chemical compound that is capable of forming a covalent bond with itself or a chemically different compound in a repetitive manner. The repetitive bond formation between monomers may lead to a linear, branched, super-branched, or three-dimensional product. Furthermore, monomers may themselves comprise repetitive building blocks, and when polymerized the polymers formed from such monomers are then termed “blockpolymers”. Monomers may belong to various chemical classes of molecules including organic, organometallic or inorganic molecules. Examples of contemplated organic monomers are acrylamide, vinylchloride, fluorene bisphenol or 3,3′-dihydroxytolane. Examples of contemplated organometallic monomers are octamethylcyclotetrasiloxane, methylphenylcyclotetrasiloxane, hexanethyldisilazane, and triethyoxysilane. Examples of contemplated inorganic monomers include tetraethoxysilane or aluminum isopropoxide. The molecular weight of monomers may vary greatly between about 40 Dalton and 20000 Dalton. However, especially when monomers comprise repetitive building blocks, monomers may have even higher molecular weights. Monomers may also include additional groups, such as groups used for crosslinking.

As used herein, the term “crosslinking” refers to a process in which at least two molecules, or two portions of a long molecule, are joined together by a chemical interaction. Such interactions may occur in many different ways including formation of a covalent bond, formation of hydrogen bonds, hydrophobic, hydrophilic, ionic or electrostatic interaction. Furthermore, molecular interaction may also be characterized by an at least temporary physical connection between a molecule with itself or between two or more molecules.

Internal power units are typically used to power other components, and include batteries, electronic circuits, capacitors, coils, and fuel cells. Contemplated internal power units may be coupled to the collar unit by any suitable method or apparatus. As used herein, the term “coupled” can be defined as fastening or otherwise joining two or more components together. It is intended that the action of “coupling” the base assembly system to another component can take place by using any suitable coupling device, composition, compound or apparatus, such as bolts, adhesives, Velcro, clamps, grips, screws, nails, magnets, suction cups, and any and all related components, such as washers and nuts.

The internal power unit may also comprise any suitable power converter and/or power source. Power units of the type generally contemplated herein are those that are manufactured and/or produced by Purcell Systems, Inc, such as the PC60, the PC130, the PCD25 or the PC25. These contemplated power units are discussed in the Examples Section. It should be understood that these power units are examples of the many different types of power units that are available and that can be coupled with the collar units. These units can provide a DC connection for supply/battery backup/battery chargers and charger boards and can also have additional DC connections (such as a 12 V) for other devices, electronic components and/or communications components and/or devices.

Contemplated external electronic components comprise circuit boards, chip packaging, dielectric components of circuit boards, printed-wiring boards, and other components of circuit boards, such as capacitors, inductors, and resistors.

As used herein, the term “electronic component” also means any device or part that can be used in a circuit to obtain some desired electrical action. Electronic components contemplated herein may be classified in many different ways, including classification into active components and passive components. Active components are electronic components capable of some dynamic function, such as amplification, oscillation, or signal control, which usually requires a power source for its operation. Examples are bipolar transistors, field-effect transistors, and integrated circuits. Passive components are electronic components that are static in operation, i.e., are ordinarily incapable of amplification or oscillation, and usually require no power for their characteristic operation. Examples are conventional resistors, capacitors, inductors, diodes, rectifiers and fuses.

Electronic components contemplated herein may also be classified as conductors, semiconductors, or insulators. Here, conductors are components that allow charge carriers (such as electrons) to move with ease among atoms as in an electric current. Examples of conductor components are circuit traces and vias comprising metals. Insulators are components where the function is substantially related to the ability of a material to be extremely resistant to conduction of current, such as a material employed to electrically separate other components, while semiconductors are components having a function that is substantially related to the ability of a material to conduct current with a natural resistivity between conductors and insulators. Examples of semiconductor components are transistors, diodes, some lasers, rectifiers, thyristors and photosensors.

Electronic components contemplated herein may also be classified as power sources or power consumers. Power source components are typically used to power other components, and include batteries, capacitors, coils, and fuel cells. Power consuming components include resistors, transistors, ICs, sensors, and the like.

Still further, electronic components contemplated herein may also be classified as discreet or integrated. Discreet components are devices that offer one particular electrical property concentrated at one place in a circuit. Examples are resistors, capacitors, diodes, and transistors. Integrated components are combinations of components that that can provide multiple electrical properties at one place in a circuit. Examples are ICs, i.e., integrated circuits in which multiple components and connecting traces are combined to perform multiple or complex functions such as logic.

Telecommunications or communications components include fiber optic cable and other optical materials, such as waveguides, data transmission wires and lines, copper wire, coax cable, keyboards and monitors and the like.

The wires, conductive devices, communications components or electronic components can be made from metals or another appropriate conductive material. As used herein, the term “metal” means those elements that are in the d-block and f-block of the Periodic Chart of the Elements, along with those elements that have metal-like properties, such as silicon and germanium. As used herein, the phrase “d-block” means those elements that have electrons filling the 3d, 4d, 5d, and 6d orbitals surrounding the nucleus of the element. As used herein, the phrase “f-block” means those elements that have electrons filling the 4f and 5f orbitals surrounding the nucleus of the element, including the lanthanides and the actinides. Preferred metals include titanium, silicon, cobalt, copper, nickel, zinc, vanadium, aluminum, chromium, platinum, gold, silver, tungsten, molybdenum, cerium, promethium, and thorium. More preferred metals include titanium, silicon, copper, nickel, platinum, gold, silver and tungsten. Most preferred metals include titanium, silicon, copper and nickel. The term “metal” also includes alloys, metal/metal composites, metal ceramic composites, metal polymer composites, as well as other metal composites.

In addition, methods of forming a power assembly system are provided herein that include: a) providing a collar unit; b) providing an internal power unit; and c) coupling the collar until to the internal power unit. Also, methods of forming a power assembly couple are disclosed herein that include: a) providing the power assembly system described herein; b) providing a meter base assembly; and c) coupling the power assembly system with the meter base assembly to form the power assembly couple. The steps of providing any of the components described herein may comprise a) ordering the component from an outside source; b) producing the component in house; or c) a combination thereof.

### EXAMPLES

PC60 Power Unit

The PC60 unit provides reliable DC power for medium duty fiber optic connected Ethernet subscriber lines. The PC60 is also an AC to DC converter. The PC60 is a compact unit designed to provide a reliable DC power source for (medium duty fiber optic connected Ethernet Subscriber devices). The switch mode supply and DC outputs protect against transient peaks from small generators and local utility power and provide a low noise, low voltage power source.

Electrical Requirement

AC/DC Power Supply

The power supply should be a switching type and shall meet the following specification:

Input Voltage

Model I—110 VAC±10%, transient condition ±20%.

Model II—220 VAC+10%, transient condition ±20%.

Input Frequency

The input voltage shall be sinusoidal and operate at 47 to 70 Hz.

Output Voltage

Measured at nominal input 110/220 VAC

| Output | Voltage (VDC) | Current (ADC) |
|---|---|---|
| V1 | 12.0 | 2.0 |
| V2 | 18.0 | 2.0 |

The ripple shall be less than 5% of each outputs nominal voltage rating.

Output Current

Each output of the power supply shall be capable of delivering 2.0 A under continuous operation.

Ripple & Noise

The ripple and noise shall be less than 5% of the nominal rated output voltage.

Output Ground

The output return shall be bypassed through a 0.01 uF, 1 KV capacitor to the chassis.

Current Limit

The power supply shall limit the maximum power used to 100 watts maximum.

Short Circuit Protection

The power supply shall incorporate a field replaceable fuse to protect against a short circuit placed directly across either output. The fuse rating shall be 2 A for Model I and 1 A for Model II.

Environmental

Operating Temperature

The power supply shall operate continuously between −20° C. to +60° C.

Storage Temperature

−35° C. to +75° C.

Humidity

The power supply shall operate continuously in an environment for which the humidity is 0 to 95% non-condensing.

Altitude Variation

The power supply shall operate between −500 to 6,000 feet. However, the unit, operating at maximum temperature, may de-rate at a factor of 1° C. per 1000 feet. It shall continue to operate after being transported in the air cargo, which is pressurized to 10,000 feet.

Life Cycle

The power supply shall exhibit an MTBF of no less than 1 million hours.

Indicator and Status

LED Status

The power supply shall be equipped with a green Status LED. The LED shall light when the power supply is energized.

Compliance

Radio Frequency Interference
FCC part 15 class B for radiated and conducted emissions; 3 db margin min.
CISPR 22 (EN55022, 1992) class B for radiated and conducted emissions
CFR 47 Part 15
VCCI (Japan) (TBD)
AS/NZS 3548 (Australia) (TBD)

Safety
UL/CSA UL60950
UL/TUV or VDE CB Report
EN 60950 (TUV mark)
CE Mark

Mechanical Requirements

Input Connection

The power supply units shall have quick disconnect male terminals for input AC connection.

Output Connection

The power supply unit's output connector shall be TBD.

Size and Weight

Dimension: 146.05 mm×50.8 mm×50.8 mm

Weight: less than 1 pounds.

TABLE 1
Mechanical Requirements

PCA dimensions: 5.75″ L × 2.0″ W × 2.0″ H
Mounting Holes: Holes must accommodate size #10 screws.
Location of holes must be agreed upon by WWP.
Weight: <1 lbs

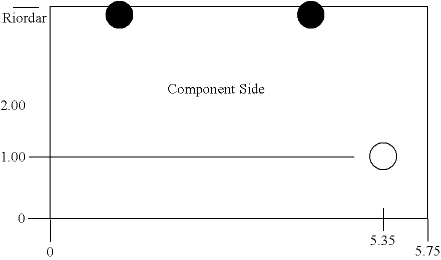

PCD 25 Power Unit

The PCD25 unit provides reliable DC input backup power for medium duty fiber optic connected Ethernet subscriber lines. The PCD25 is a DC version of the PC25 that is designed to work in tandem with the PC60. The PC25 (see Table 1) and PC-130 are suitable for outdoor use and can be installed anywhere in the world that uses power between 85-240 Volts AC with either 50 or 60 Hz. The PCD25 is a compact unit designed to provide a reliable DC input backup power for medium duty fiber optic connected Ethernet Subscriber devices. PCD25 provides a switched mode medium duty power output of 12VDC and a battery charger output of 12VDC for large capacity batteries 12 V @ 7 AH allowing full recharge in the minimum possible time. The switch mode supply, DC output and heavy duty batteries protect against transient peaks from small generators and provide a noise free alternate power source.

Electrical Requirement

DC/DC Power Supply

The power supply should be a switching type and shall meet the following specification:

1. Input Voltage

The input voltage shall be between 15 to 18 VDC.

2. Input Frequency

The input voltage shall be direct current DC.

3. Battery Charger Voltage Setting

The battery charger output voltage shall accommodate a 12VDC nominal battery pack and shall vary according to the charge state of the battery; the charger output can swing from 11 VDC to 13.8 VDC maximum.

4. Output Voltage

The output voltage shall be at least 11 VDC minimum to 14 VDC maximum at 1.2 A load. The ripple shall be less than 0.05Vrms.

5. Output Current

The power supply shall be capable of delivering 12V @ 1.2 A under continuous operation regardless of the battery charger current.

6. Output Ground

The output return shall be connected through a 0.01 uF, 1KV capacitor to the chassis.

Disconnect Switch

NOT APPLICABLE

Battery

Type

The battery shall be sealed, Lead-Acid rechargeable, and maintenance free—12V @ 7 AH pack.

Voltage

The battery shall provide an output voltage of 11.0 to 13.8 VDC at 1.2 A load.

Operation Time

The battery shall have enough power to backup Ethernet device for TBD hours at TBD Load current.

Recharge Time

The battery shall be fully recharged within 8 hours after discharge while supplying 1.2 Amp to the load.

Low Voltage Disconnection

The battery shall be disconnected from the load when terminal voltage drops below 10.1Vdc to avoid any damage. It shall remain disconnected until DC power is restored.

Output Short Circuit Protection

The power supply unit shall have short circuit protection against the output load being accidentally shorted, to protect the internal battery and power supply circuitry.

Environmental

Operating Temperature

The power supply shall operate continuously between −20° C. to +60° C. Storage Temperature −35° C. to +75° C.

Humidity

The power supply shall operate continuously in an environment for which the humidity is 0 to 95% non-condensing.

Altitude Variation

The power supply shall operate between −500 to 6,000 feet. However, the unit, operating at maximum temperature, may de-rate at a factor of 1° C. per 1000 feet. It shall continue to operate after being transported in the air cargo, which is pressurized to 10,000 feet.

Life Cycle

The battery shall operate continuously for a minimum of 2 years.

Indicator and Status

LED Status

The power supply unit shall have up to three Status LED's and 3 isolated status signals as described below:

| SIGNAL | TYPE | FUNCTION |
|---|---|---|
| Output Present | GRN LED | Lit when 12 VDC output is present |
| On Line | GRN LED | Lit when BBU is operating on AC power |
| | | (option) |
| Battery Missing | RED LED | Lit when Battery is not installed (option) |
| On Battery | SIGNAL | Low signal when operating on battery |
| Battery Present | SIGNAL | Low signal when battery is installed |
| Low Battery | SIGNAL | |

Compliance

Radio Frequency Interference

FCC part 15 class B for radiated and conducted emissions; 3 db margin.
CISPR 22 (EN55022, 1992) class B for radiated and conducted emissions
CFR 47 Part 15
VCCI (Japan)
AS/NZS 3548 (Australia)

Safety
UL/CSA UL60950
UL/TUV or VDE CB Report
EN 60950 (TUV mark)
CE Mark

Mechanical Requirements

Input Connection

The power supply units shall have a TBD cord with appropriate AC plug.

The power supply unit has a pair of binding post at the rear of the power supply for the connection of external Battery or DC sources; ie solar panel.

Output Connection

The power supply unit's output connector shall be TBD.

Battery Accessibility

The battery shall be easily replaceable and located within the cabinet enclosure less than 2 feet from the charger.

Size and Weight
Dimension: 110.7 mm×63.5 mm×38.1 mm
Weight: less than 1 pound for 7 AH version, less than 1 pound for 4.5 AH version

PC130 Power Unit

Input Characteristics

| | Min. | Max. | Units |
|---|---|---|---|
| Voltage | 85 | 264 | Vrms |
| Current | — | 3 | Amps RMS |
| Frequency | 47 | 63 | Hz |
| Inrush Current | | 30 (60) | Amps @ 115 V (@ 230 V) |

Harmonics: per EN61000-3-2, Class A and EN61000-3-3

Output Characteristics

| | Min | Nom. | Max. | Units |
|---|---|---|---|---|
| Voltage (line) | 44 | 48 | 56 | Volts DC |
| Current | — | 2.7 + 1.7 | — | Amps O/P + Charger |
| Current Limit | N/A | N/A | 5.5 | Amps @ 48 Volts |
| Ripple Voltage | — | — | 2.0 | Vrms (20 MHz Bandwidth) |

Battery Characteristics

| | Min. | Typ. | Max. | Units |
|---|---|---|---|---|
| Capacity | — | 17 | — | Amp-Hour |
| Low Volt Disconnect | 34 | 36 | 38 | Volts DC |
| Low Battery Warning | 42 | — | 45 | VDC |
| Run Time | — | 5 (−02) | — | Hours |
| Recharge Time | — | — | 12 | Hours to full |
| | | | | capacity |

UPS Alarm Logic Table

| | | AC | Charger | On | Low | Replace | Battery Not |
|---|---|---|---|---|---|---|---|
| | | Normal | Fail | Battery | Battery | Battery | Connected |
| Signal 1 | On Battery | L | L | H | H | L | L |
| Signal 2 | Replace Battery | L | x | L | H | H | X |
| Signal 3 | Battery Exists | L | x | L | L | L | H |
| Signal 4 | Charger Good | L | H | X | X | L | L |

(Opto-Coupler open collector output > 1 milliamp 30 V)

Visual Status Signals—Optional
Output Good: Green LED lit when 12 Volt output is present.
On AC: Green LED lit when supply is operating on AC power.

Battery Missing: Green LED lit when battery is not installed.

Environmental

| | Min. | Max. | Units |
|---|---|---|---|
| Operating Temperature | −33 | +55 | ° C. |
| Storage Temperature | −40 | +70 | ° C. |
| Humidity | — | 100 | % non-condensing |

Mechanical
Dimensions: 7.0″L×4.0″W×2.0″H (Power Supply/Charger)
Weight: <5 lbs.
Mounting holes provided for panel mounting
AC Input connector: Molex equivalent (3941 5 pin, 0.154 spacing)
Output connector: Molex TBD equivalent (3941 8 pin, 0.154 spacing) External to the UPS, there is a single output (including logic) connector.

Logic connector: JST or Molex equivalent (2011 4 or 5 pin, 2 mm spacing)

Agency Approvals

| | |
|---|---|
| EMC: | EN50091-2: 1995, FCC 47 CFR Part 15 |
| | (15.107e, 15.109 g as a minimum) |
| ESD: | EN61000-4-2, Level 3/Class 3 |
| EMI Immunity | EN61000-4-3, Level 3 |
| EFT: | EN61000-4-4, Level 3 |
| Surge Immunity: | EN61000-4-5, Level 3/Class 3 |
| Safety: | EN50091-1: 1993, EN50091-1-1: 1996, |
| | UL1778, CSA 22.2 No. 107.1-9.5 |

Thus, specific embodiments and applications of compositions and methods to construct, produce and use power assembly systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

TABLE 1
Input Characteristics

| | Min. | Max. | Units |
|---|---|---|---|
| Voltage | 85 | 265 | Vrms |
| Current | — | 0.5 | Amps RMS |
| Frequency | 47 | 70 | Hz |

Output Characteristics

| | Min. | Nom. | Max. | Units |
|---|---|---|---|---|
| Voltage (line) | 11 | 12 | 14 | Volts DC |
| Voltage (battery) | 11 | 12 | 13.8 | Volts DC |
| Current | — | — | 1.2 | Amps |
| Current Limit | N/A | N/A | N/A | Amps @ 12 Volts |
| Ripple Voltage | — | — | 0.1 | Vrms |

Battery Characteristics

| | Min. | Typ. | Max. | Units |
|---|---|---|---|---|
| Capacity | — | 7.2 | — | Amp-Hour |
| Low Volt Disconnect | 10.1 | 10.2 | 10.3 | Volts DC |
| Low Battery Warning | 10.8 | 11.2 | 11.5 | VDC |
| Run Time | TBD | — | — | Hours |
| Recharge Time | — | — | TBD | Hours to 90% |
| | | | | capacity |

Status Signals on Interface Cable

| Signal | Description | Conn./pin # |
|---|---|---|
| On Battery | Active low when operating from | CN3 |
| | battery - isolated | |
| Battery Present | Active low when battery is | CN4 |
| | installed - isolated | |
| Low Battery | Active low when battery voltage | CN5 |
| | is below 11.0 Volts, or when no | |
| | battery installed, Battery | |
| | Present = high - isolated | |

Visual Status Signals

| | |
|---|---|
| Output Present | Green LED lit when 48 Volt output is present. |
| On Line | Green LED lit when BBU operating on AC |
| | power (OPTION ONLY). |
| Battery Missing | Red LED lit when battery is not installed |
| | (OPTION ONLY). |

Environmental

| | Min. | Max. | Units |
|---|---|---|---|
| Operating Temperature | −20 | +60 | ° C. |
| Storage Temperature | −33 | +75 | ° C. |
| Humidity | — | 95 | % non-condensing |

Mechanical

PCB Dimensions: 6.92″ L × 2.5″ W × 2.0″ H
Weight: <4 lbs.
Mounting holes provided for panel mounting
AC Input connector: Molex 26-60-4050 or equivalent
Output connector: Molex 26-60-4040 or equivalent

1. A power assembly system, comprising:
a collar unit; and
an internal power unit, wherein the internal power unit is coupled to the collar unit.

2. A power assembly couple, comprising:
the power assembly system of claim 1; and
a meter base assembly, wherein the meter base assembly is coupled to the power assembly system to form the power assembly couple.

3. The power assembly couple of claim 2, wherein the meter base assembly comprises a meter base and a meter.

4. The power assembly couple of claim 2, wherein the meter base assembly is located outdoors.

5. The power assembly couple of one of claims 2 or 4, wherein the meter base assembly is coupled to a residential location.

6. The power assembly couple of claim 2, wherein the meter base assembly measures metered electricity.

7. The power assembly of claim 1, wherein the collar unit is ejection molded.

8. The power assembly of claim 1, wherein the collar unit protects the internal power unit.

9. The power assembly of claim 8, wherein the collar unit protects the internal power unit from environmental conditions.

10. The power assembly couple of claim 2, wherein the couple further comprises an external electronic component.

11. A method of forming a power assembly system, comprising:
providing a collar unit,
providing an internal power unit; and
coupling the collar until to the internal power unit.

12. A method of forming a power assembly couple, comprising:
providing the power assembly system of claim 11,
providing a meter base assembly; and
coupling the power assembly system with the meter base assembly to form the power assembly couple.

13. The method of claim 11, further comprising coupling the power assembly couple to an external electronic component.

14. The method of claim 12, wherein the external electronic component comprises a circuit board.

15. The method of claim 12, wherein the meter base assembly comprises a meter base and a meter.

16. The method of claim 12, wherein the meter base assembly is located outdoors.

17. The method of one of claims 12 or 16, wherein the meter base assembly is coupled to a residential location.

18. The method of claim 12, wherein the meter base assembly measures metered electricity.

19. The method of claim 11, wherein the collar unit is ejection molded.

20. The method of claim 11, wherein the collar unit protects the internal power unit.

21. The method of claim 20, wherein the collar unit protects the internal power unit from environmental conditions.

22. The method of claim 12, wherein the couple further comprises an external electronic component.
